(19) United States
(12) Patent Application Publication
(10) Pub. No.: US 2006/0012979 A1
(43) Pub. Date: Jan. 19, 2006

(54) Rechargeable halogen lantern

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/893,738

(22) Filed: Jul. 16, 2004

(51) Int. Cl. F21L 4/02

(52) U.S. Cl. 362/184

(57) ABSTRACT

The present invention is relates to relates to a rechargeable halogen lantern with a handle and two supporting legs. Said handle is set at a same level of this lantern to provide a holding position. Said supporting legs can rotate through an attached hinge to any position within 270 degrees circular arc. A handle is structured in a rectangular shape. It is attached to said housing. A front and rear of the handle are equipped with stripes so user could carry the product with ease. Supporting legs are connected with said housing. When an adjustable hinge is tightened, said supporting legs are firmly fixed in one position. However, said supporting legs can also provide rotating positions through said adjustable hinge to any position within 270 degrees circular arc. They provide support for said housing in a horizontal position to get the best lighting angle.

### BACKGROUND OF THE PRESENT INVENTION

The present invention is relates to a rechargeable halogen lantern and more particularly, it relates to a rechargeable halogen lantern with a handle and two supporting legs. Said handle is set at a same level of this lantern to provide a holding position. Said supporting legs can rotate through an attached hinge to any position within 270 degrees circular arc.

1. Field of Invention

Handheld halogen lantern with focused beams or spotlights or searchlights, whether battery-powered or line-powered, are commonly used by military, law enforcement, fire and rescue personnel, security personnel, hunters and recreational boaters among others for nighttime surveillance in any application where a high intensity spotlight is required. The conditions of use are highly varied, but generally require the light to deliver a desired field of view at long distances, be reliable, durable and field maintainable in order for it to be practically used in the designed applications. Typically the light is hand carried and must be completely operable using simple and easily access manual controls which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

2. Description of Related Arts

U.S. Pat. No. 6,685,337 provides a lanterns which combine both a flashlight with a candle together to ensure said lantern can still light up when power source is done or batteries are all used up. However, the lighting range, lighting angles and the lighting power of a candle are minimal. Such lantern light up by a candle will not be the most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. The mounting is a tripod mount so that the portable searchlight may be fixed in the field to a tripod with the second device. The mounting on the handle is a thumb screw mount to permit mounting of an optical detection device onto the searchlight and rigidly fixed to the housing. However, this lantern provide without no ability to move any angle to obtain a better light range.

### SUMMARY OF THE PRESENT INVENTION

The main object of the present invention is to provide a rechargeable halogen lantern having a supporting means and such supporting mean can provide an ability to rotate and/or to move any angles within 270 degree circular arc.

Another object of the present invention is to provide a rechargeable halogen lantern having an ability to adopt difference power source supplies.

Another object of the present invention is to provide a rechargeable halogen lantern having a supporting means and such supporting mean can provide an adjustable mean with a tight or loose positions so as to controlling such supporting legs in a locked position or in a rotating position to reach the best lighting range and lighting angles.

Accordingly, to achieve the above objects, a rechargeable halogen lantern comprises:
a rectangular housing, inside of it contains a mean of lighting source;
a plurality of reflector is fixed around said mean of light source; and
a transparent front flat board.

A seal packing collar is connecting a inner portion of said transparent front flat board and said reflector which resides inside of an annular nut. Said annular nut providing a fixed position and a disassembled position on front portion of said housing. Surface of said annular nut, which is located in front of said housing, set an annular shock proof nut. It is made of rubber or other soft material to prevent said rechargeable halogen lantern from shocks or quakes when excessive external force applied to it.

### BRIEF DESCRIPTION OF THE DRAWINGS

FIG. 1 is a front view of the present invention.

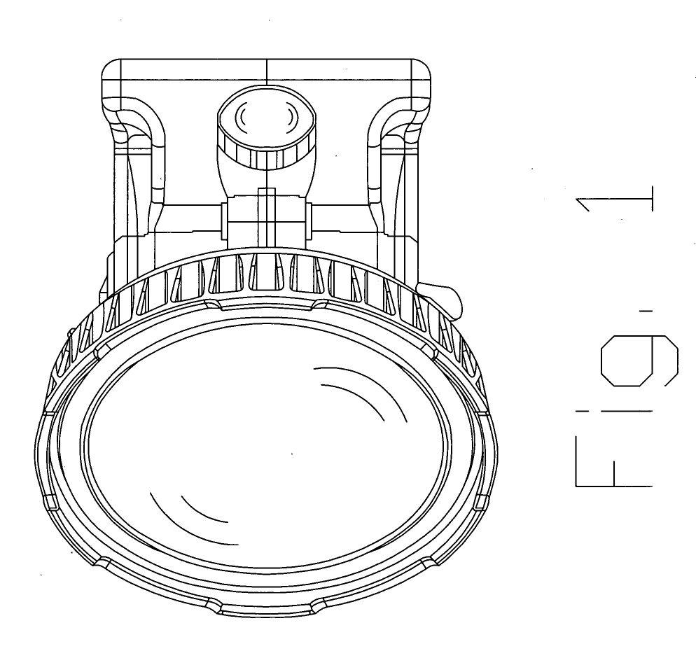

FIG. 2 is a rear view thereof.

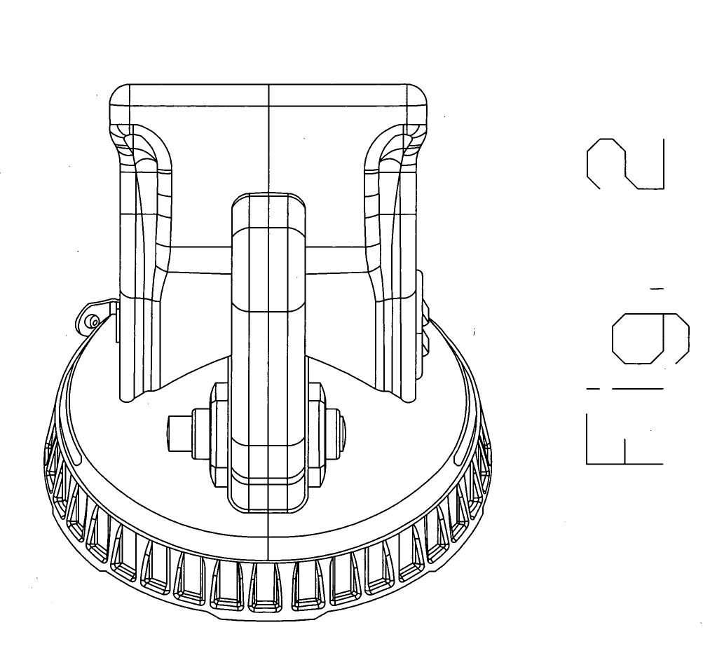

FIG. 3 is a side view thereof.

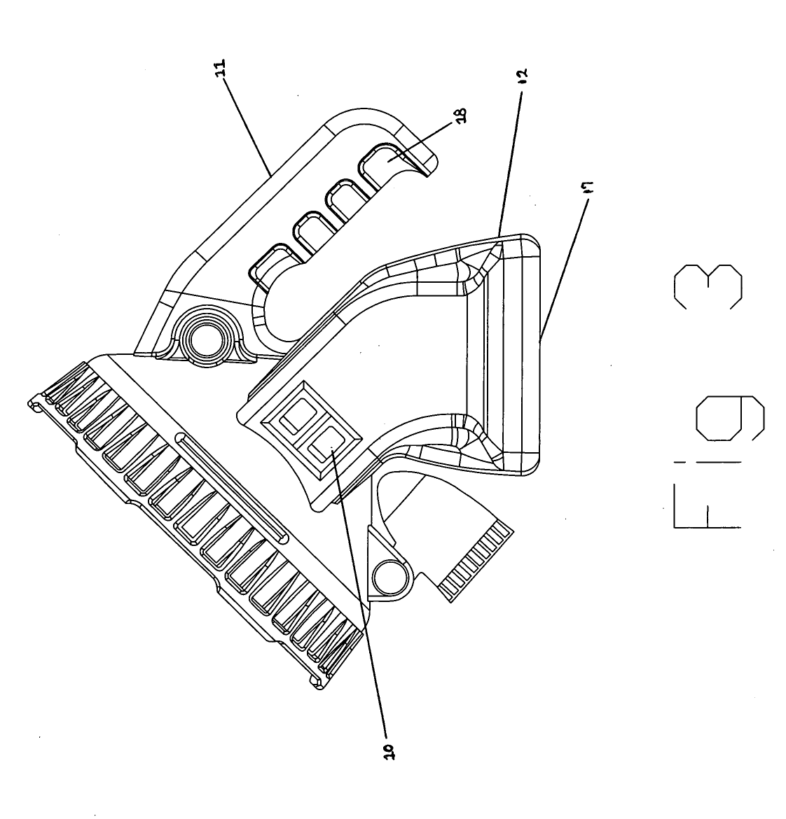

FIG. 4 is another side view of thereof.

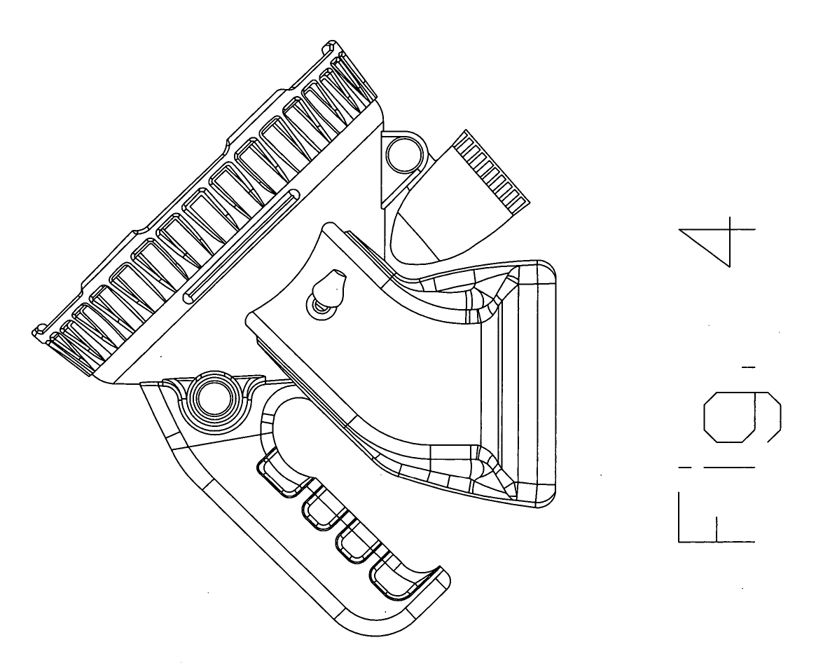

FIG. 5 is a top view thereof.

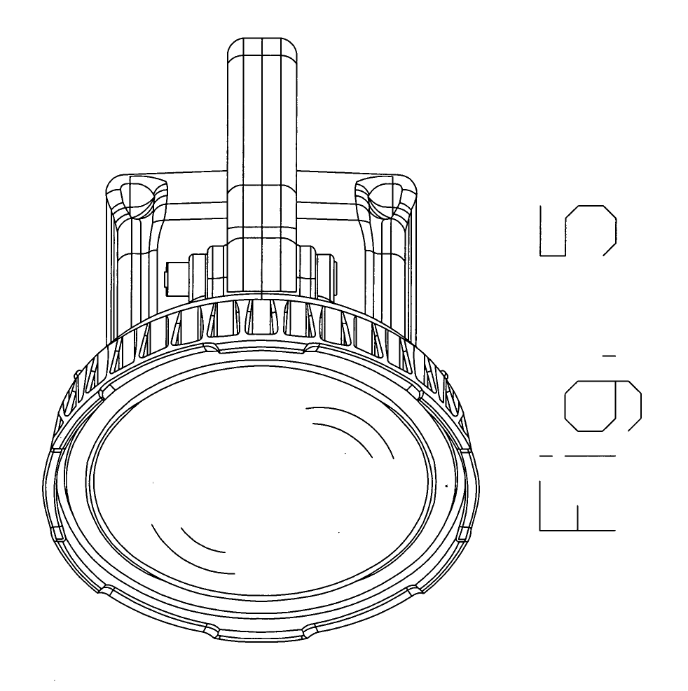

FIG. 6 is an underneath view thereof.

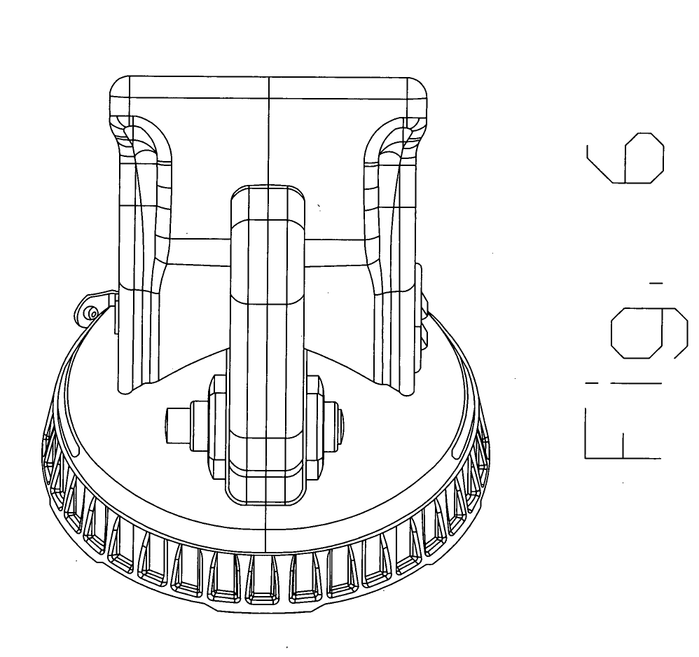

FIG. 7 is an isometric side view thereof.

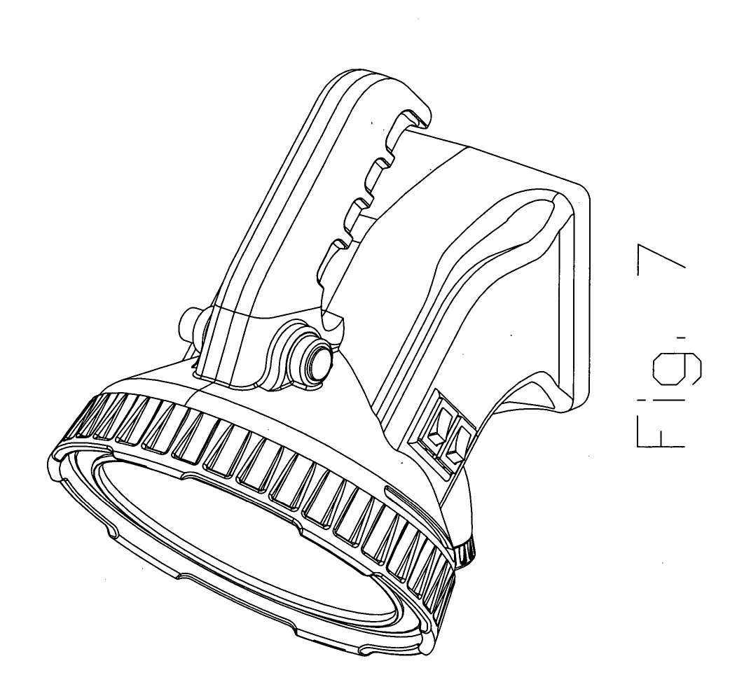

FIG. 8 is a side view with handle turned 180 degree.

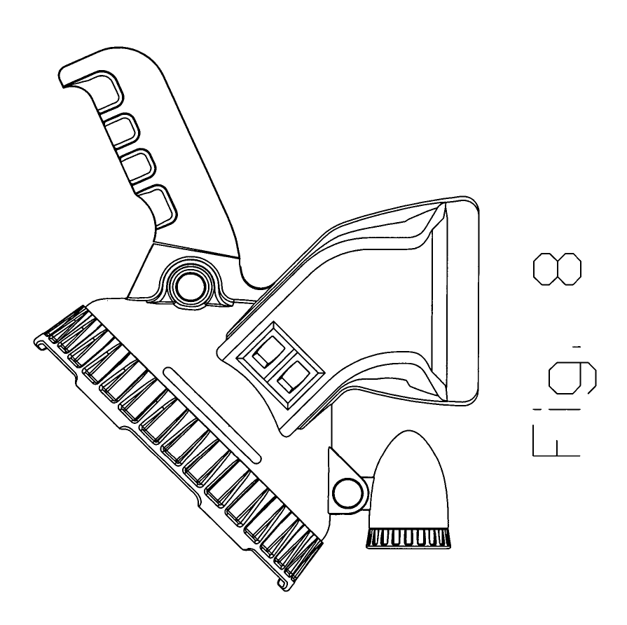

FIG. 9 is a sectional view.

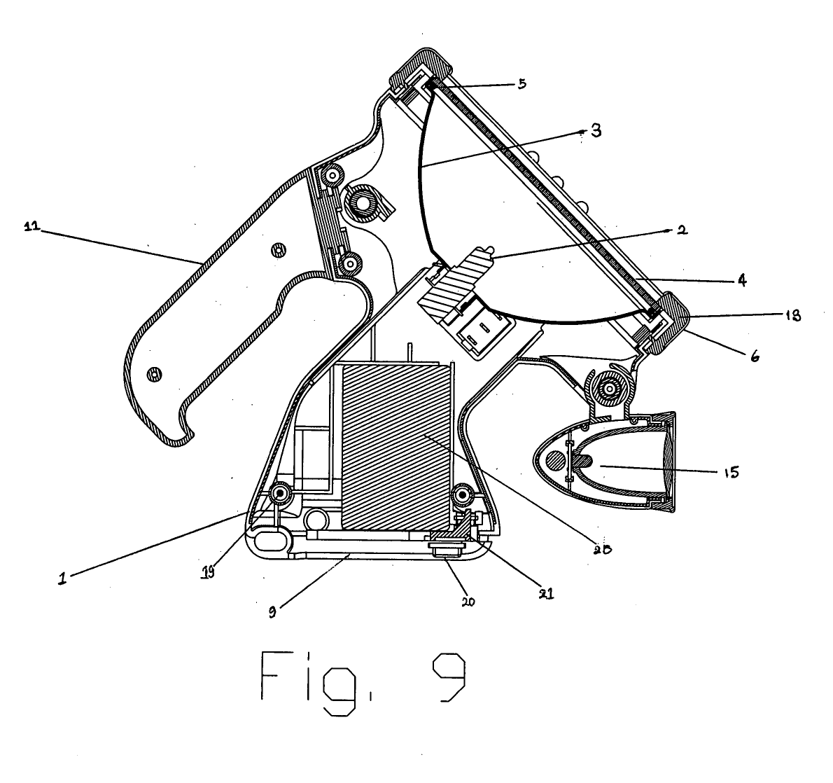

FIG. 10 place holder explanation.

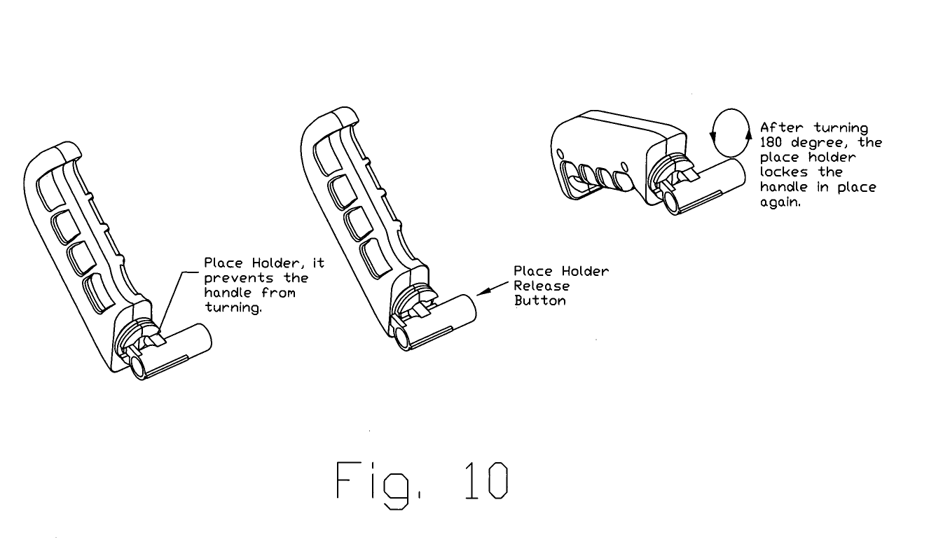

FIG. 11 is a handle assembly view.

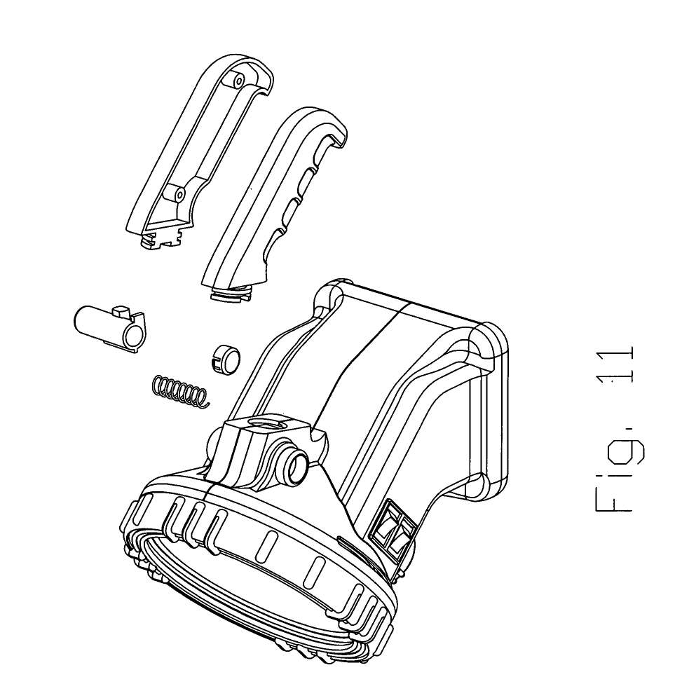

FIG. 12 is a side view of handle

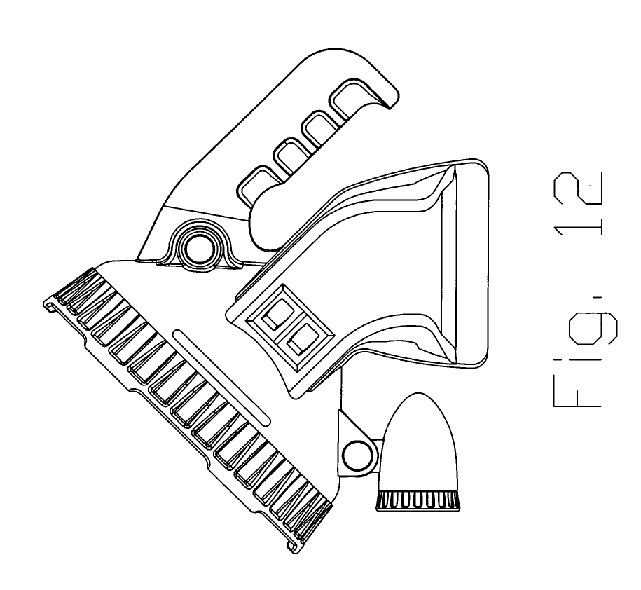

FIG. 13 is a side view of light.

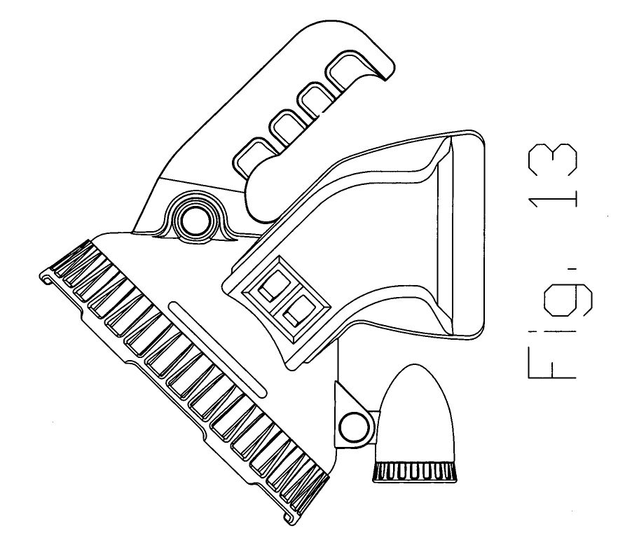

FIG. 14 is a detail sectional view of A.

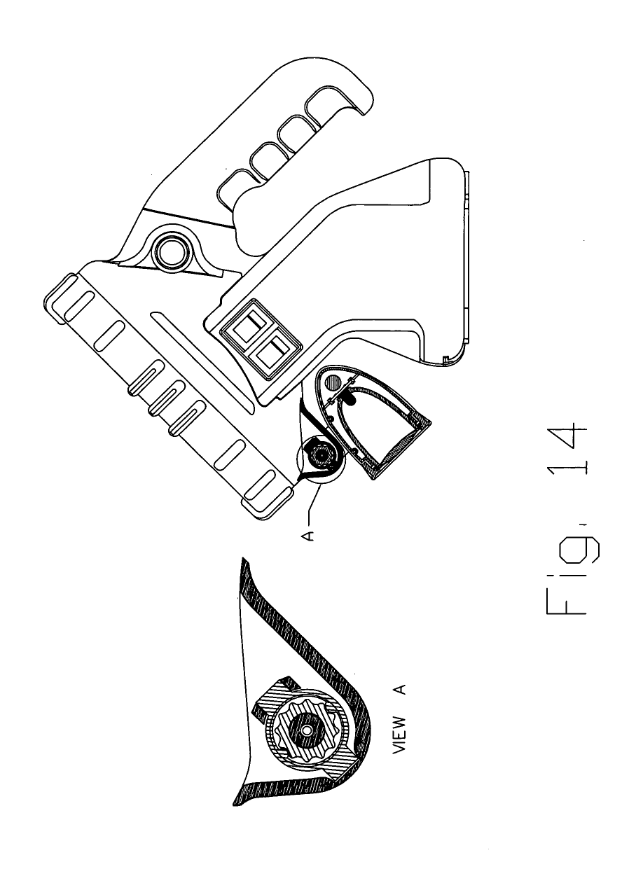

### DETAILED DESCRIPTION OF THE PREFERRED EMBODIMENT

The present invention, rechargeable halogen lantern comprises a rectangular housing (1), inside of it contains a mean of lighting source (2), a parabolic reflector (3) and a transparent front flat board (4). A seal packing collar (5) is connecting an inner portion of said transparent front flat board (4) and said reflector (3) which resides inside of an annular nut (6). Said annular nut (6) providing a fixed position and a disassembled position on front portion of said housing (1). Surface of said annular nut (6), which is located in front of said housing, set an annular shock proof nut (13). It is made of rubber or other soft material to prevent said rechargeable halogen lantern from shocks or quakes when excessive external force applied to it.

As shown in figures, a lighting source (2) has an energy saving florescent light bulb (15), which is located on a light base (21). Electricity is provided by a power source (7) within said housing (1). Electricity current goes through power cord to the insides of electrical circuitry (8) of said housing (1) and transformer (22), while connects power receptacle (9), on/off switch (10), and links up with energy saving florescent bulb (15). Obviously, it can draw electricity either from AC power outlet provided from public utility or from the chargeable battery directly. The described electrical circuitry (8) and transformer (22) are located inside of power package (23), to prevent it from being touched when changing the battery. The light base is fixed in front of the power box (25)

A handle (11) is structured in a rectangular shape. It is attached to said housing (1). A front and rear of the handle (11) are equipped with stripes (18) so user could carry the product with ease.

Supporting legs (12) are connected with said housing (1). When an adjustable hinge (14) is tightened, said supporting legs (12) are firmly fixed in one position. However, said supporting legs (12) can also provide rotating positions through said adjustable hinge (14) to any position within 270 degrees circular arc. They provide support for said housing (1) in a horizontal position to get the best lighting angle.

A battery cover (17) is located at rear portion of said housing (1). Metal screws (24) tightly locked a battery cover (17) to the rear bump of said housing (1). A seal packing collar (21) fastens the light fixture's rear inside (1) with a front end of said battery cover (17). Said battery cover (17) provides disassembling position or a fixed position at rear portion of said housing (1). Batteries can be changed when said battery cover (17) and said housing (1) are separated. Surface of said battery cover (17) contains a rubber or soft material made sealing nut (19). There is a lid (20) on said sealing nut (19) that can seal the entrance of said external receptacle (9), thus prevent water and is more durable. Said rechargeable halogen lantern is quipped with angle adjustable supporting legs (12). When hands are occupied, the photoelectron searchlight can be firmly set on the table, floor or other flat surfaces with supporting legs. Both DC (direct current, mostly in battery form) and AC (alternate current provided from public utility), can be used for said rechargeable lantern.

What is claimed is:

1. A rechargeable halogen lantern comprises:
a rectangular housing, inside of it contains a mean of lighting source;
a plurality of reflector is fixed around said mean of light source; and
a plurality of transparent front flat board.
A plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shock proof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach the best lighting range and lighting angles; and
having a handle attached to said housing providing mean of carrying.

2. A rechargeable halogen lantern as recited in claim 1, wherein, said rechargeable halogen lantern is further comprises:
at least one light bulb,
at least one arc shaped reflector,
at least one set of main switch,
at least one power receptacle for external electricity,
at least one transformer, and
at least one set of circuitry and power supply.

3. A rechargeable halogen lantern as recited in claim 1, wherein supporting legs can provide an adjustable mean with a tight or loose positions so as to controlling such supporting legs in a locked position or in a rotating position to reach the best lighting range and lighting angles through said attached hinge to any position within 270 degrees circular ark. Said legs provide supports for said housing.

4. A rechargeable halogen lantern as recited in claim 1, wherein said rechargeable halogen lantern is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

5. A rechargeable halogen lantern as recited in claim 1, wherein said rechargeable halogen lantern comprises a lighting source, has an energy saving florescent light bulb, which is located on a light base. Electricity is provided by a power source within said housing. Electricity current goes through power cord to the insides of electrical circuitry of said housing and transformer, while connects power receptacle, on/off switch, and links up with energy saving florescent bulb.

6. A rechargeable halogen lantern as recited in claim 1, wherein said rechargeable halogen lantern can draw electricity either from AC power outlet provided from public utility or from the chargeable battery directly.

7. A rechargeable halogen lantern as recited in claim 1, wherein said rechargeable halogen lantern further comprises:
a handle in a rectangular shape is longitudinally attached to said housing. A front and rear of the handle are equipped with stripes so as to provide a mean of carrying.

8. A rechargeable halogen lantern as recited in claim 1, wherein said rechargeable halogen lantern further comprises:
a battery cover is located at rear portion of said housing. Metal screws tightly locked a battery cover to the rear bump of said housing. A seal packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.

9. A rechargeable halogen lantern as recited in claim 2, wherein supporting legs can provide an adjustable mean with a tight or loose positions so as to controlling such supporting legs in a locked position or in a rotating position to reach the best lighting range and lighting angles through said attached hinge to any position within 270 degrees circular ark. Said legs provide supports for said housing.

10. A rechargeable halogen lantern as recited in claim 2, wherein said rechargeable halogen lantern is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

11. A rechargeable halogen lantern as recited in claim 2, wherein said rechargeable halogen lantern comprises a lighting source, has an energy saving florescent light bulb, which is located on a light base. Electricity is provided by a power source within said housing. Electricity current goes through power cord to the insides of electrical circuitry of said housing and transformer, while connects power receptacle, on/off switch, and links up with energy saving florescent bulb.

12. A rechargeable halogen lantern as recited in claim 2, wherein said rechargeable halogen lantern can draw electricity either from AC power outlet provided from public utility or from the chargeable battery directly.

13. A rechargeable halogen lantern as recited in claim 1, wherein said rechargeable halogen lantern further comprises:
a handle in a rectangular shape is longitudinally attached to said housing. A front and rear of the handle are equipped with stripes so as to provide a mean of carrying.

14. A rechargeable halogen lantern as recited in claim 1, wherein said rechargeable halogen lantern further comprises:
a battery cover is located at rear portion of said housing. Metal screws tightly locked a battery cover to the rear bump of said housing. A seal packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.
